(19) United States
(12) Patent Application Publication
(10) Pub. No.: US 2012/0290519 A1
(43) Pub. Date: Nov. 15, 2012

(54) METHOD AND APPARATUS FOR IDENTIFICATION OF LINE-OF-RESPONSES OF MULTIPLE PHOTONS IN RADIATION DETECTION MACHINES

(75) Inventors: Rejean Fontaine, Sherbrooke (CA); Jean-Baptiste Michaud, Montreal (CA); Charles-Antoine Brunet, Sherbrooke (CA); Roger Lecomte, Sherbrooke (CA)

(73) Assignee: SOCPRA SCIENCES SANTE ET HUMAINES S.E.C, Sherbrooke (CA)

(21) Appl. No.: 13/284,168

(22) Filed: Oct. 28, 2011

Related U.S. Application Data
(60) Provisional application No. 61/408,299, filed on Oct. 29, 2010.

(30) Foreign Application Priority Data
Oct. 29, 2010 (CA) 2719381

(51) Int. Cl. G01T 1/164; G01T 7/00; G06N 3/02; G01C 21/00

(52) U.S. Cl. 706/20; 250/206.1; 250/362; 250/252.1

(57) ABSTRACT

The present disclosure relates to a method and an apparatus for identifying line-of-responses (LOR) of photons. A radiation detection machine measures the photons. LOR identification errors are then mitigated using pattern recognition of the measurements. In some embodiments, the photons may comprise positron annihilation photons, each position annihilation photon being associated with one or more scattered photons. In yet some embodiments, pattern recognition may be implemented in a neural network.

### TECHNICAL FIELD

The present disclosure relates to the field of radiation detection machines and, more specifically, to a method and an apparatus for identifying photon line-of-responses.

### BACKGROUND

Various types of radiation detection machines are used for a broad array of applications. For example, Positron Emission Tomography (PET) is a medical imaging modality that allows studying metabolic processes of cells or tissues such as glucose transformation in energy. PET uses the coincident detection of two co-linear 511 keV photons emitted as a result of positron annihilation to reconstruct the spatial distribution of positron-emitting radiolabelled molecules within the body. Current PET human scanners can achieve 4-6 mm resolution and the scanner ring is large enough to let the patient occupy a relatively small portion of the field of view. On the other hand, small animal PET scanners have a smaller ring diameter (˜15 cm) and achieve a higher resolution than their human counterpart (≦2 mm) through, for example, an increased detector pixel density. In addition, because of the small diameter ring and large aspect ratio of long (˜2 cm) versus small section (<4 mm²) detectors that are pointing toward the scanner center, error may occur on the position of detection of the annihilation photons (511 keV).

Avalanche PhotoDiodes (APD)-based detection systems, and pixelated detection systems, which allow individual coupling of scintillation crystal to independent Data AcQuisition (DAQ) chains, have been considered for PET scanners, for example for small animal applications. This approach however suffers from poor intrinsic detection efficiency due to the photon interaction processes and from electronic noise problems generated by the APD photodetectors themselves. That noise is a contributor to all measurements and significantly hinders signal processing of the detection.

FIG. 1 is a schematic diagram of a basic operation of a PET scanner. A radioactive tracer is injected into a subject 52. The radiotracer decay ejects an anti-electron, or positron (β⁺), which in turn annihilates with an electron (β⁻), yielding a total energy of 1022 keV re-emitted in the form of two quasi-collinear but anti-parallel 511-keV annihilation photons 54, 55. Interaction of those photons with matter permits their detection, provided such interaction occurs in the dedicated detectors of the PET scanner 56. When the photons are detected, a trajectory of the annihilation photons can be computed. The trajectories of several hundreds of thousands of annihilations are then used to reconstruct an image.

PET detectors are usually arranged in ring fashion, to allow for optimal radial coverage, and a given scanner often has a stack of such rings to augment its axial field-of-view. The detectors still cover a limited solid angle around the patient or subject, and photons not emitted towards a detector remain undetected. Aside from that, the interaction with matter is probabilistic in nature, and a photon may not necessarily be detected even if emitted toward a detector. Finally, when interacting with matter, a photon can transfer all its energy at once, in which case the process is called a photoelectric absorption, or only part of it. In a partial energy absorption case, the photon undergoes what is then called Compton scattering, where remaining energy is re-emitted in the form of a scattered photon obeying the Compton law, according to equation (1):

$${E}_{scattered} = \frac{{E}_{incident}}{1 + \frac{{E}_{incident}}{511 keV} ( 1 - cos θ )} \qquad ( 1 )$$

where E_{scattered} is the remaining re-emitted photon energy, E_{incident} is the incident photon energy and θ is the angle between the two photon trajectories. FIG. 2 illustrates a geometry of the Compton law. A single annihilation photon 58 can thus undergo Compton scattering 60 in the patient/subject itself, or undergo a series of Compton scatterings in the detectors. FIG. 2 shows a simple scattering scenario, wherein the single photon 58 deposits a part of its energy and is scattered at an angle θ that is a function of that deposited energy.

To properly reconstruct the image, a virtual line is accurately traced on the line spanned by the annihilation photons trajectory. That trajectory is called Line-of-Response (LOR) 62. But because of scattering, probabilistic detection and limited solid angle coverage, the scenarios and combinations of photoelectric or scattered, detected or not detected photons are limitless. It has been shown that for detections involving any Compton scattering, one cannot compute the annihilation trajectory with a certainty level high enough for all scenarios to guarantee acceptable image quality with a sufficiently low computational burden to be practically feasible, and they are currently all rejected as unusable. Only detections involving two photoelectric 511-keV photons are kept, because they involve an unambiguous trajectory computation, but they typically account for less than 1% of all detected photons.

The scanner has consequently a low ratio of usable detections versus injected radioactive dose (known in PET as the sensitivity). That low sensitivity is becoming a critical issue, in terms either of acquisition time, image quality or injected dose, especially in small-animal research where doses can sometimes be considered therapeutically active, or where tracers can saturate neuro-receptors. Sensitivity is critical in small-animal PET, and including more of the discarded detections would increase it. However lowering the energy threshold compromises spatial resolution.

A few efforts have attempted to increase sensitivity by lowering the detection energy threshold and incorporating Compton-scattered photons in the image reconstruction. This has proven to be quite problematic, since recovering the correct photon trajectories and properly determining the sequence of interactions is rendered difficult by the quasi infinite number of scenarios potentially involved. It is difficult to recover the correct trajectory of the annihilation photons, or LOR, among the several possibilities of any given coincidence. In small-animal scanners based on avalanche photodiodes, the image resolution and contrast can be impaired by the relatively low success rate of even the most sophisticated methods.

While the foregoing problems have been described in relation to PET scanners, similar concerns also apply in other types of radiation detection machines capable of detecting photons. Non-limiting examples may comprise Compton cameras, photon calorimeters, scintillation calorimeters, Anger cameras, single positron emission computed tomography (SPECT) scanners, and the like.

Therefore, there is a need for a method and apparatus for identifying line-of-response of photons that compensates for losses of spatial resolution at high sensitivity levels.

### BRIEF DESCRIPTION OF THE DRAWINGS

Embodiments will be described by way of example only with reference to the accompanying drawings, in which:

FIG. 1 is a schematic diagram of a basic operation of a PET scanner;

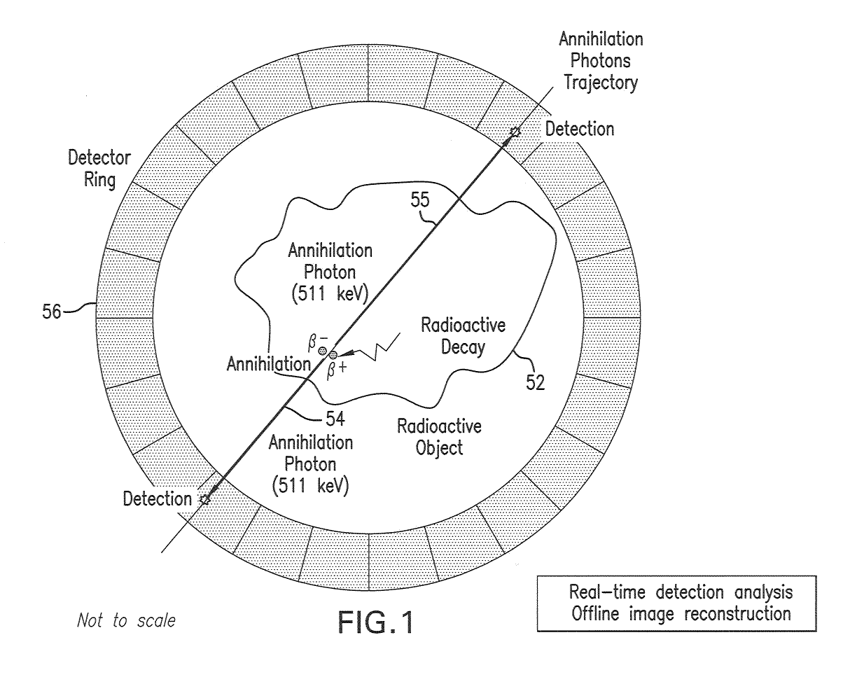

FIG. 2 illustrates a geometry of the Compton law;

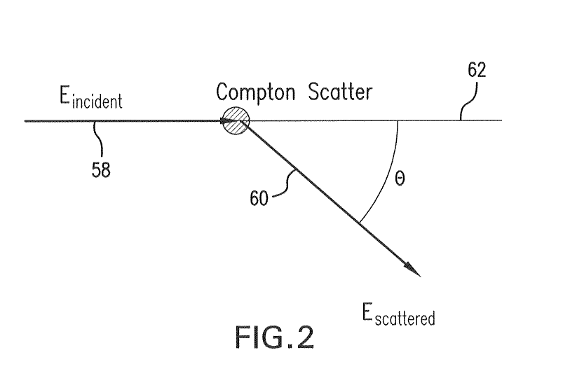

FIG. 3 is a sequence of steps of a method for identifying line-of-responses (LOR) of multiple photons according to an embodiment;

FIG. 4 is a block diagram of an apparatus for identifying line-of-responses (LOR) of multiple photons according to an embodiment;

FIG. 5 is a logical diagram showing embodiments of a method integrated within a data processing flow of a PET scanner;

FIG. 6 is a schematic diagram of a simple inter-crystal scatter scenario;

FIG. 7 is a schematic diagram exemplifying a coincidence rotated in a PET scanner;

FIG. 8 is a 2D post analysis view of a 6D decision space;

FIG. 9 is an illustrative example of a method for analysis of Compton-scattered photons according to an embodiment;

FIG. 10 is an example of a pre-processing sequence broken down into a number of optional operations;

FIG. 11 is a histogram of distances travelled by scattered photons;

FIG. 12 is a graph showing a distribution of triplet line-of-responses identification errors;

FIG. 13 is 2D example of a situation wherein the Compton law is not sufficient to distinguish a forward-scattered photon from a backscattered photon;

FIG. 14 is a first zoomed view of a region of interest of images reconstructed using photons processed with the method of the present disclosure;

FIG. 15 shows profiles of levels of gray within FIG. 14;

FIG. 16 is a view of position-dependent sensitivity in a simulated dummy scanner;

FIG. 17 is a second zoomed view of a region of interest;

FIG. 18 shows profiles of levels of gray within FIG. 17, as seen in a first direction;

FIG. 19 shows profiles of levels of gray within FIG. 17, as seen in a second direction;

FIG. 20 is a third zoomed view of a region of interest; and

FIG. 21 is a comparison between an image obtained with traditional methods and images obtained using enhanced pre-processing.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems of identifying line-of-response of photons that compensates for losses of spatial resolution at high sensitivity levels.

The present disclosure introduces a method for use with a radiation detection machine, and an apparatus incorporating a radiation detecting machine, for identifying line-of-responses (LOR) of multiple photons. Photons are detected and measured in the radiation detection machine. The measurements are pre-processed according to known or expected properties of the photons. Pattern recognition is then used to mitigate LOR identification errors remaining in the pre-processed measurements.

In some embodiments, the method and apparatus are for use in positron emission tomography (PET). Discrimination may be made between scattered photons and photoelectric photons lying on the LORs. A PET scanner identifies a plurality of triplets, each triplet comprising a detected photoelectric photon whose energy level is within a range indicative of positron annihilation and two detected scattered photons whose energy sum is also within the positron annihilation energy range. A processor may align the triplets, first by rotation and translation, bringing the photoelectric photons on a same axis. The processor may also rotate further the triplets about the axis of the photoelectric photons, bringing the scattered photons in a same plane. A neural network may be used to mitigate LOR identification errors.

The following terminology is used throughout the present disclosure:
Positron annihilation photons: photon emitted when a positron transforms into energy with an electron, for example when positrons emitted by a radioactive source collide with matter in a region of interest, in a scanner.
Photoelectric photons: photons which deposit all of their energy at a single point of interaction with matter.
Scattered photons: photons re-emitted following collision of a photon with a scatterer, where part of the initial energy was deposited in the scatterer.
Compton scattering: dispersion in matter of energy from an incident photon, which produces scattered photons.
Triplet: a simple form of a Compton scatter effect comprising, from 2 incident photons, a photoelectric photon and two scattered photons; more complex forms may comprise a larger number of scattered photons and no photoelectric photon.
Line-of-response (LOR): trajectory of photons emitted as a by-product of nuclear decay, such as the trajectory of annihilation photons.
Radiation detection machine: apparatus capable of detecting photons.
Scanner: a sensor or a group of sensors part of a radiation detection machine.
Positron emission tomography (PET): medical imaging technique using radiation detection for studying metabolic processes of cells or tissues.
Pre-processing: any type of numerical processing of measurements applied prior to their presentation to a pattern recognition process.
Pattern recognition: calculation of an output based on an input and on known or expected properties of data.
Mitigation of errors: diminution or minimization of the impact of the LOR identification errors on the performance of a radiation detection machine.
Implicit measurement values: values that are not supplied to, but assumed by a pattern recognition process.
Artificial intelligence: a class of analysis aiming at using non-traditional techniques, other than explicit mathematical modeling, for reducing chances of errors in a system.
Algebraic methods or algebraic classifiers: a class of pattern recognition where a decision is made within an input space using relationships to bounded regions within that space.
Neural network: interconnected processing elements implementing a form of artificial intelligence.
Geometrical processing: a form of pre-processing.
Numerical processing: any geometry transformation, filtering or mathematical analysis.
Filtering: a process or system for reducing undesired artifacts in photon measurements.
Processor: in the context of the present disclosure, a computer, a central processing unit (CPU), a graphical processing unit (CPU), a Field-Programmable Gate Array (FPGA), a Digital Signal Processor (DSP), an Application-Specific; Integrated Circuit (ASIC), or any device capable of performing computation operations, or any combination thereof.

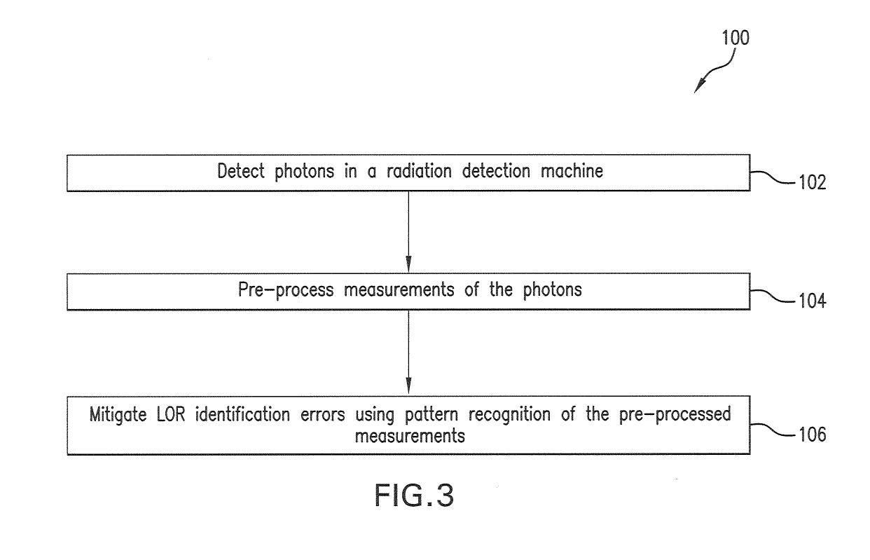

FIG. 3 is a sequence of steps of a method for identifying line-of-responses (LOR) of multiple photons according to an embodiment. The method may be implemented as a sequence 100 comprising a step 102 of detecting photons in the radiation detection machine. At step 104, pre-processing is made of measurements of the detected photons. Mitigation of LOR identification errors is then made at step 106 by using pattern recognition of the pre-processed measurements. An image of an object present in the radiation detection machine may then be constructed based on a plurality of LORs.

Although explicit analysis of the measurements may be made, mitigation of the LOR identification errors may rely on an implicit representation of the measurements used for pattern recognition. Pre-processing of the measurements of photons may involve geometrical processing, numerical processing and filtering. Such pre-processing facilitates pattern recognition by improving performance, reducing complexity, or both.

In an embodiment, the photons may be detected through photoelectric interaction within a detector. In the same or other embodiment, the photons may be subjected to Compton scattering within the detector. As an example, the radiation detection machine may be a positron emission tomography (PET) apparatus, or scanner, in which some of the detected photons are positron annihilation photons. Identification may be made, in the scanner, of a plurality of positron annihilation photons as photoelectric photons having an energy level within a range indicative of positron annihilation. On the other hand, positron annihilation pholon(s) may further be detected as one or more scattered photons, whose energy sum is within the positron annihilation energy range. The method may discriminate between photoelectric photons and scattered photon lying on the LOR and may further comprise identification of a plurality of photon groups, each photon group comprising a detected photoelectric photon and one or more detected scattered photons. Pre-processing the measurements of the photons then helps a determination of the LORs, based on geometries and numerical properties of a plurality of photoelectric photons and normalizing, within a predetermined range, energy measurements of the photoelectric photons.

In an embodiment, pattern recognition may be performed using algebraic classification methods.

In an embodiment, pattern recognition may be performed using an artificial intelligence technique, for example using a neural network. Mitigating LOR identification errors using pattern recognition of the pre-processed measurements then comprises a pattern recognition analysis of the normalized measurements, executed by the neural network. In some embodiments, the neural network may have, as a part of a pattern recognition process, a feedforward multilayer architecture, a hyperbolic tangent function as a non-linear activation function, and/or be trained using back-propagation of the error when compared to simulated Monte-Carlo data.

Before normalization, the photoelectric photon trajectories may be aligned by rotation and translation, in order to bring the trajectories on a same axis. After this step of aligning and before normalization, rotating further the photoelectric photons about their axis may bring the photon groups in a same plane. Of course, due to measurements impairments and to noise, it is expected that some of the photoelectric photon trajectories cannot be brought on the same axis and that some of the photon groups cannot be brought on the same plane. Pre-processing and pattern recognition applied to photon measurements nevertheless provides sufficient information for the identification of LORs.

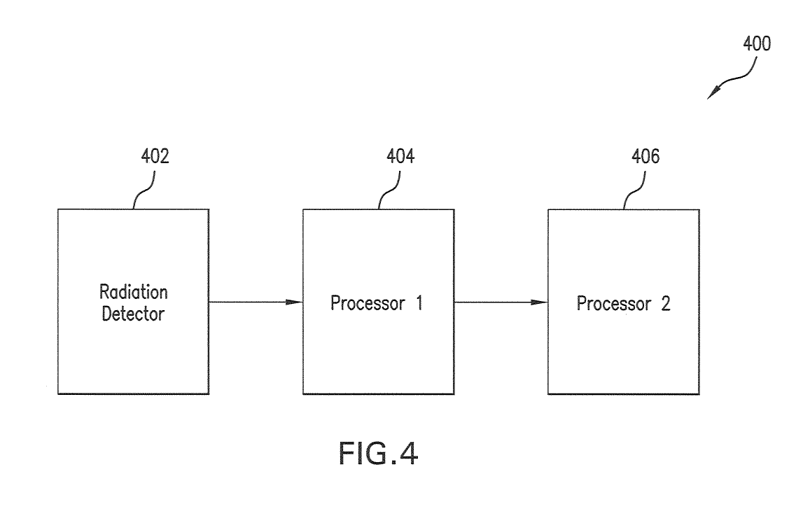

FIG. 4 is a block diagram of an apparatus for identifying line-of-responses (LOR) of multiple photons according to an embodiment. An apparatus 400 comprises a radiation detector 402 that provides photon measurements to a first processor 404. The first processor 404 pre-processes the photon measurements. Results of the pre-processing are then presented to a second processor 406 that mitigates LOR identification errors using pattern recognition of the pre-processed measurements. The radiation detector may for example comprise a scanner for detecting photoelectric photons resulting from positron annihilation.

In some embodiments, the first processor 404 may align trajectories of the detected photons by rotation and translation, such that the trajectories are brought on a same axis, The first processor 404 may also rotate further the photoelectric photons about their axis to bring the photons in a same plane. The first processor 404 may further normalize the measurements of photons within a predetermined range. In the same or other embodiments, the second processor 406 may comprise a neural network. The neural network may compute the LOR as an output range between −1 and 1. The neural network may further be trained using an optimization algorithm. The neural network may also statistically minimize the LOR identification errors arising from the measurements of photons.

Various embodiments of system for identifying line-of-response of annihilation photons, as disclosed herein, may be envisioned. One such embodiment involves a method and an apparatus for the analysis of photons, for example Compton-scattered photons, in radiation detection machines. The method and apparatus do not require explicit handling of any overly complex, non-linear and probabilistic representations of the Compton interaction scenarios, and are immune to scanner's energy, time and position measurement errors.

In an embodiment, with an energy threshold set as low as 50 keV, triple coincidences analyzed are simple inter-crystal Compton scatter scenarios where one photoelectric 511-keV detection coincides with two detections whose energy sum is also 511-keV. The value 511-keV, or alternately an energy range around the value 511-keV, represents an energy level of positron annihilation. Instead of traditional Compton interaction mathematical models, pattern recognition, which may be implemented as artificial intelligence analysis, for example using a neural network, is used to determine a proper Line-of-Response (LOR) for that coincidence. The following disclosure presents the method for the analysis of Compton-scattered photons and, in particular pre-processing operations used to simplify data fed to the neural network, pre-processing in order to significantly improve LOR computation. The disclosure then presents a Monte Carlo analysis of the method with various point and cylinder sources. A simulated scanner geometry is purposely made to encompass worst-case conditions seen in today's PET scanners, including small diameter, poor photoelectric fraction, and poor 35% Full Width at Half Maximum (FWHM) energy resolution. With the present method and apparatus, LOR identification error is low, in a range of 15 to 25% while sensitivity increases in a range of about 70 to 100%. Images, obtained with overall very good quality, are presented.

In an attempt to improve the efficiency ratio, it is worth recognizing which specific Compton scattering cases are certain enough and can be kept for image reconstruction. However, due to the distribution of the data and the particular operating conditions, that recognition is somewhat impractical using traditional logic, which would impose prohibitive computing power requirements.

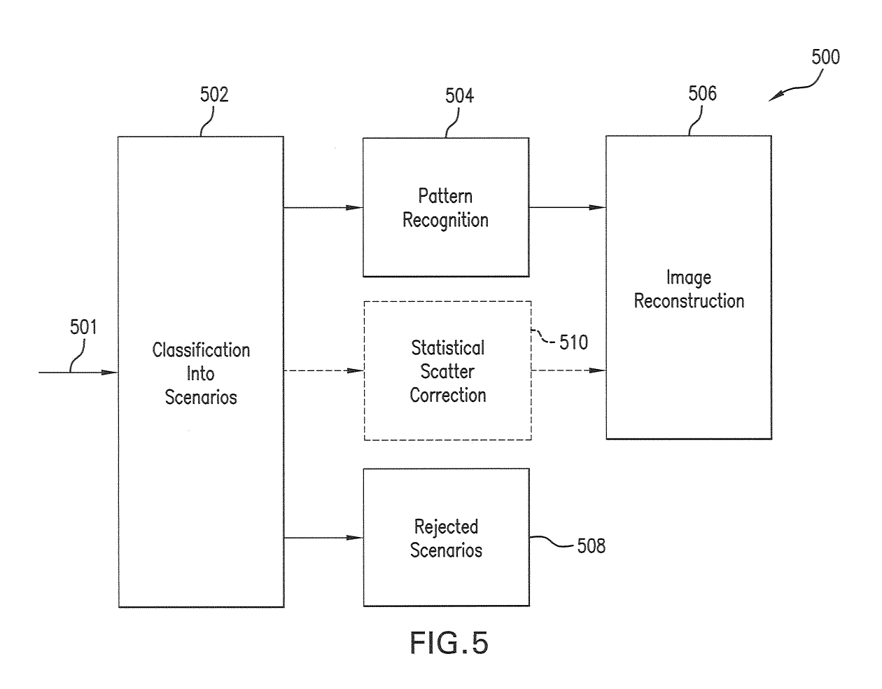

Accordingly, a method and an apparatus, which do not require explicit handling of any overly complex, nonlinear and probabilistic representations of the Compton interaction scenarios, and which are immune to the scanner's energy, time and position measurement errors, are used. Artificial intelligence may be used for that purpose. FIG. 5 is a logical diagram showing embodiments of a method integrated within a data processing flow of a PET scanner. Integration of the method within a PET scanner forms a non-limiting example, as the method could be integrated in other medical imaging apparatuses.

Block diagram 500 shows that measurements 501 obtained from a radiation detection device, for example radiation detector 402 of FIG. 4, in which an object is to be imaged, are classified 502 into scenarios, for example Compton scattering scenarios. Results from such classification may be deemed valid and be presented to a pattern recognition process 504 for identifying LORs. Following pattern recognition, the LORs are used for reconstructing 506 an image of the object. Some scenarios cannot be identified and classified and are thus rejected 508. The pattern recognition process 504 may replace traditional explicit correction of scattering effects 510. This explicit correction may not be present in other embodiments, as explained hereinbelow.

Indeed, the method is an alternative to more “traditional” use of mathematics in other applications, especially when the problem is complex and noisy. Different pattern recognition algorithms have different inherent error mitigation capabilities. For instance, artificial intelligence processes and devices, such as for example neural networks, do not require any explicit representation of the problem and can be trained directly with noisy data. They act as universal approxirriators by way of learning. Simultaneous operation on the inputs, combined with no explicit representation of the problem at hand, gives neural networks good immunity to input noise.

The output of a single-layer neural network is a non-linear distortion of the linear combination of its inputs. In other words, the network forms a hyper-plane in a n-dimension hyper-space defined by the inputs and then performs a non-linear operation on that hyper-plane. In that sense, a neural network with several layers can be viewed as an elaborate non-linear pattern recognition engine, which can compute in which region of the input space a particular input combination lays.

If a large number of measurements pertinent to a given coincidence are fed as inputs to a neural network, then the network can be trained, using those measurements, to recognize the correct and incorrect LORs as separate regions of the input space.

This method is thus suited to resolve the Compton-scattering problem. The application and adaptation of the method to that problem are described hereinafter. Although the present description presents a proof of concept for the application of neural networks to the sensitivity problem in PET, applications of the method are not restricted to that particular case. Likewise, while the present description provides an illustration of a method and apparatus using a neural network, any method or system, such as for example those using algebraic processes or any artificial intelligence system capable of localizing a LOR for a Compton scatter following pre-processing, may substitute for the neural network. References to “neural networks” are presented as examples and should not be understood as limiting.

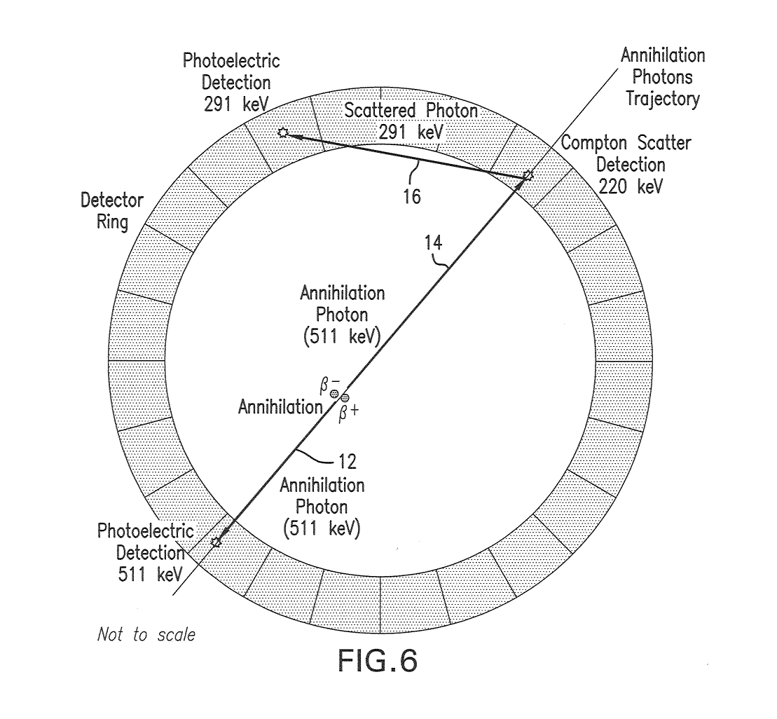

In an embodiment the method may analyze a highly prevalent Compton scattering scenario, when one 511-keV photon and two 511-keV-sum photons are detected in coincidence. This is a simplest case of Inter-Crystal Scatter (ICS). FIG. 6 is a schematic diagram of a simple inter-crystal scatter scenario. For sake of simplicity, the demonstration is done here in 2D but the reasoning is readily extendable to 3D, One photoelectric annihilation photon 12 is shown with a pair of photons 14, 16 involved in Compton scattering.

The method disclosed herein operates in two phases. In a first phase, pre-processing prepares measurements for subsequent analysis by a pattern recognition process embodied as an artificial intelligence process, for example in a neural network. The neural network itself identifies the photon lying on the LOR in a second phase.

A pre-processing goal is to make the measurements separable into correct and incorrect LOR regions, and it does so in two phases: simplify measurements, and then order the measurements.

Separation is used because of the sheer number of possibilities, even for a simple scenario. Even in the mathematical space defined by all combined measurements available in a scanner, those measurements, when taken as is, overlap and do not directly provide separation between the correct and incorrect LORs.

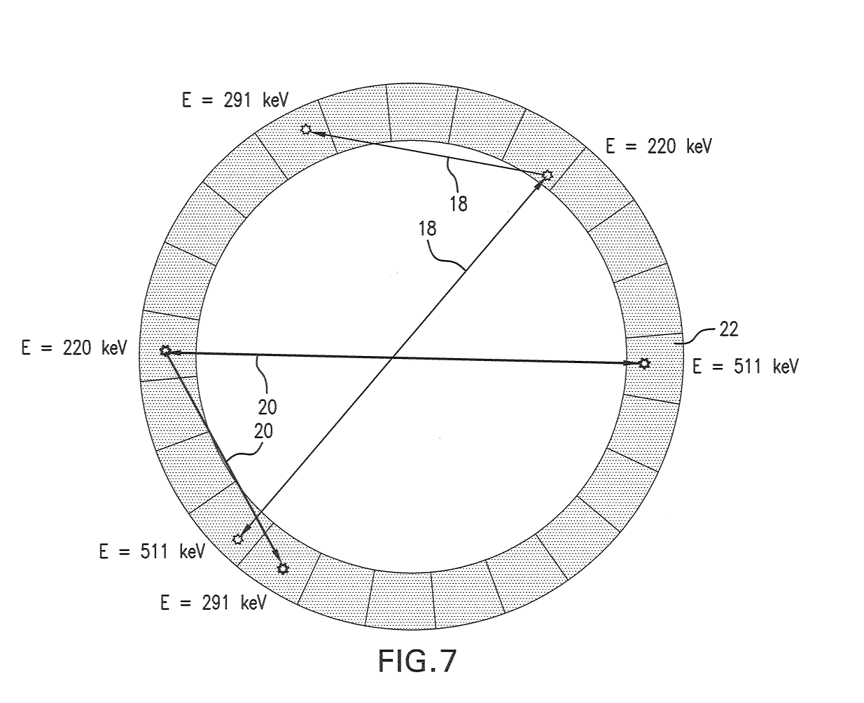

FIG. 7 is a schematic diagram exemplifying a coincidence rotated in a PET scanner. A given coincidence 18 is rotated 20 so that the photoelectric annihilation photon lies in a rightmost detector 22. Simplification is achieved by removing the circular superposition of the input space arising from the radial symmetry of the scanner, by means of a rotation about its longitudinal axis such that the single 511-keV photon lies at chosen coordinates. The coordinates and energy of that photoelectric annihilation photon are now implicit, and need not to be fed to the network.

Ordering forms another pre-processing phase. Photons are simply sorted from the highest energy (photon a) to the lowest (in this case, photon b) to remove another region superposition in the input space arising from random arrival of photon information at the coincidence processing engine.

Enhanced pre-processing can involve normalization of the coordinates and energy. Normalization scales the measurements to known values between ˜1 and 1 or 0 and 1, and produces the positive side-effect that the method is virtually machine-independent. Embodiments of enhanced pre-processing are described hereinbelow.

After preprocessing, the LOR is computed. However, because of measurement noise and imprecision, there still exists some overlap between the regions. The overlap is addressed within a decision as to which photon lies on the LOR. A neural network tackles both tasks. In practice, any technique not using explicit representation of the problem and which is able to abstract noise may alternatively be used.

Each neuron in a network can be described using the traditional representation of artificial neurons of equation (2):

$$output = f ( {\sum }_{n = 1 … number of inputs} {w}_{n} \cdot {input}_{n} + {bias}_{n} ) \qquad ( 2 )$$

where wₙ are the weights associated with each input and ƒ is an arbitrary function, often a non-linear function. Neurons can be organized in layers, where the outputs of the neurons in one layer constitute the inputs to the next layer.

In this example, the neural network is fed with simplified measurements pertaining to the ICS coincidence: the x,y coordinates and energy of the two remaining 511-keV-sum photons, for a total of 6 inputs. Table 1 shows information retained from the chosen Compton scenario, forming the 6 inputs, and fed to the neural network.

TABLE 1

| Symbol | Description |
|---|---|
| xₐ | Normalized Cartesian coordinates of non-511-keV photon a |
| yₐ | |
| x_{b} | Normalized Cartesian coordinates of non-511-keV photon b |
| y_{b} | |
| eₐ | Normalized energy of non-511-keV photon a |
| e_{b} | Normalized energy of non-511-keV photon b |

The network then computes which of photon a (high energy) or photon b (low energy) lies on the LOR, effectively making abstraction of the measurement noise. The following notation is used:

Photon a is a high energy photon before analysis;

Photon b is a low energy photon before analysis;

Photon 1 is one of photons a or b that lies on the LOR after analysis;

Photon 2 is the other one of photons a or b that does not lie on the LOR after analysis.

A neural network needs to be trained. Since there is no efficient method for computing with good certainty which photons are on the LOR, use of real-life data is not appropriate. Simulation data may then be used for training. In this example, the network is trained with data representative of the poorest characteristics obtained with current technology, to prove that the method has widespread application. Thus the energy resolution is chosen as 35% FWHM, the inner diameter of the scanner is set at 11 cm and the detector size is quantized at 2.7×20 mm (in 2D). In this example, the trained neural network has 7 neurons organized in two layers, with 6 neurons on the first layer and a single neuron on the second layer. The function ƒ is in this case a hyperbolic tangent, denoted tan h( ). Weights and bias are listed in Table 2, which shows input weights and input biases for the first layer, and in Table 3, which shows output weights and bias of the second layer.

| | xₐ | yₐ | x_{b} | y_{b} | eₐ | e_{b} | bias |
|---|---|---|---|---|---|---|---|
| Neuron 1 | 0.1863 | 1.0107 | 0.5493 | −0.6769 | −1.1686 | 0.4683 | 1.0751 |
| Neuron 2 | −46.1132 | −29.8168 | 46.1259 | 29.6919 | −1.1850 | −0.9160 | 1.4913 |
| Neuron 3 | −21.9790 | 23.0727 | 21.9960 | −22.9643 | −0.4640 | −0.4730 | −0.4782 |
| Neuron 4 | 7.8396 | −5.5638 | −5.0541 | 4.2560 | 0.9666 | 2.3451 | −1.7044 |
| Neuron 5 | 2.6939 | −2.9409 | −2.8600 | 3.2044 | 9.0387 | −16.4902 | −2.3092 |
| Neuron 6 | −34.2142 | −45.0004 | 34.3800 | 44.9778 | −1.1315 | −0.4947 | 0.1514 |

TABLE 3

| w₁ | w₂ | w₃ | w₄ | w₅ | w₆ | bias |
|---|---|---|---|---|---|---|
| 26.8547 | −49.2374 | 35.1667 | −7.6034 | 2.7646 | 46.9476 | 42.3964 |

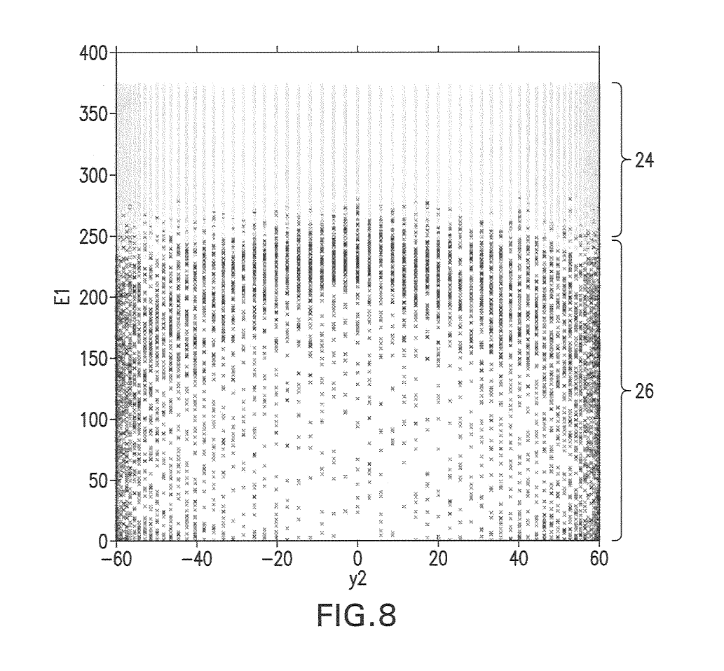

FIG. 8 is a 2D post analysis view of a 6D decision space. The decision space is considered as having six (6) dimensions (6D) because it relies on six (6) distinct inputs of Table 1. Post-analysis results are projected in two of the six dimensions of the decision space, for worst-case data similar to the training set. For photon 1, post-analysis is shown in two of the dimensions of the 6D decision space. E₁ is an energy in keV of the photon on the LOR. y₂ is a y coordinate in millimeters of the photon not on the LOR. Shown is the separation of the space into distinct areas 24 and 26 of FIG. 8. Though noisy, areas 24 and 26 are clearly distinguishable. Area 24 shows where photon a, high energy, was on the LOR. Area 26 shows where a photon b, low energy, was on the LOR.

Although demonstrated here in 2D, the method can be used in 3D. Either the 3D geometries can be brought back in a 2D plane through rotations and translations, or more inputs to the neural networks can be used to accommodate the extra information. Details are provided hereinbelow in the description of embodiments of enhanced pre-processing.

As versatile as the described method might be, all Compton-scattering cases might not be analyzed with a single physical realization of the method. Parallel physical realizations might be used. Also, a coincidence sorting engine may be used for recognizing which coincidence may be analyzed. That sorting engine may also use artificial intelligence techniques, such as for example fuzzy logic.

Since the present method directly computes the correct LOR, traditional mathematical or statistical correction methods 510 used to compensate for the inclusion of erroneous Compton-scattered photons, as shown in FIG. 5, are not required.

The method described herein may be physically realized through different approaches as, for example and not limited to, offline software running on traditional computers, on Digital Signal Processors (DSPs), as real-time hardware in an integrated circuit or in a Field Programmable Gate Array (FPGA), or as any combination of those means.

The method and apparatus of the present disclosure comprise, amongst others, the following features: The method can analyze Compton-scattered photons. The method can compute, among detected photons resulting from a single disintegration, which ones resulted from the interaction of the original annihilation photons.

Proof of concept of the method has been made by its application in PET, but the method may also be applied to other radiation detection machines. The method does not use any explicit representation (neither certain nor probabilistic) of the phenomenons and scenarios analyzed. While correction is made necessary in ordinary systems by the inclusion of incorrectly analyzed Compton-scattered photons in the reconstruction data, the present method does not require traditional mathematical and/or statistical processing of inter-detector scatter prior to image reconstruction. The method can use measurements readily available in the machine, for example coordinates of detections and detected energy, or indirectly computed physical quantity from those measurements. The method can work on normalized quantities, be machine-independent and hence be ported easily to other machines.

The method uses two phases: A first phase, called pre-processing, simplifies subsequent analysis by reducing the total number of scenarios to be considered. The first phase, among other goals and/or effects, makes the problem separable. In this case, the problem is separable when, in the mathematical space defined by the measurements used, the decision as to which detection was from an original annihilation photon and which was not, that decision forms a neat or noisy boundary in that space, as shown for example in FIG. 8. The first phase can be achieved, for example, by means of rotations and translations in space, in order to superpose otherwise distinct geometrical symmetries of a machine, as illustrated in FIG. 7. A second phase, called decision, specifically decides which detection was produced by an original annihilation photon, and which other detection came from a secondary Compton-scattered photon. Of course, the second phase may relate to a plurality of such detections. The second phase is done using one or more processes capable of abstracting measurement noise. The second phase can be done, for example, using artificial intelligence techniques such as artificial neural networks trained from measurements.

The method can be assisted, either at the first or second phase, from external help. The external help can take the form, for example, of any sequential or parallel analysis, based on other decision and/or simplification criterions. The external help, for example, can consist in fuzzy classification of one coincidence into different scenarios to be considered for Compton analysis, as shown in FIG. 5.

The above mentioned proof of concept shows that, potentially, one would not need explicit handling of the nonlinear and probabilistic representations of the interaction scenarios based on Compton kinematics, while still being somewhat immune to the scanner's energy, time and position measurement errors. It is expressed that correct and incorrect LORs may be recognized by identifying correct and incorrect LOR regions in a pre-processing phase.

In an embodiment, enhanced pre-processing further reduces LOR identification errors. The proposed method is indeed an alternative to more “traditional” mathematics. It does not require any explicit representation of the problem, namely the Compton kinematics law, the various probabilistic models of detection, the incoherent (Compton) scattering effective cross-section and/or the scattering differential cross-section as per the well-known Klein-Nishina formula. It uses learning through direct training with the noisy data. Simultaneous operation on available information, combined with no explicit representation of the problem at hand, gives the method good immunity to measurement impairments like poor energy resolution and detection localization accuracy.

In an embodiment, one inter-crystal Compton scatter scenario offers triple coincidences, where one photoelectric 511-keV detection coincides with detection of two scattered photons whose energy sum is also 511-keV. These triple coincidences, or triplets, may be used to identify a correct LOR. An embodiment of the method analyzes this highly prevalent Compton scattering scenario, where one 511-keV photon and two 511-keV-sum photons resulting from scattering are detected in a triple coincidence, forming a triplet. Alternately, triplets can be selected using a more relaxed criterion, in which the sum of all three detections' energy is 1022 keV. The method recovers the LOR from this simplest case of Inter-Crystal Scatter (ICS). Recitation of Compton scattering by reference to “triplets” is made solely in order to simplify the present description and should not be understood as limiting. The method is not limited to triple coincidences and may be extended to four (4) Compton scatters or more. The method and apparatus presented herein are therefore applicable to multiple Compton scatters. Moreover, the method is not limited to the simple Compton scenario described herein, in which one photon has energy indicative of positron annihilation while two more photons have an energy sum indicative of positron annihilation. The method and apparatus presented herein are therefore applicable to any scenario where it is desired to find a LOR within multiple photon measurements.

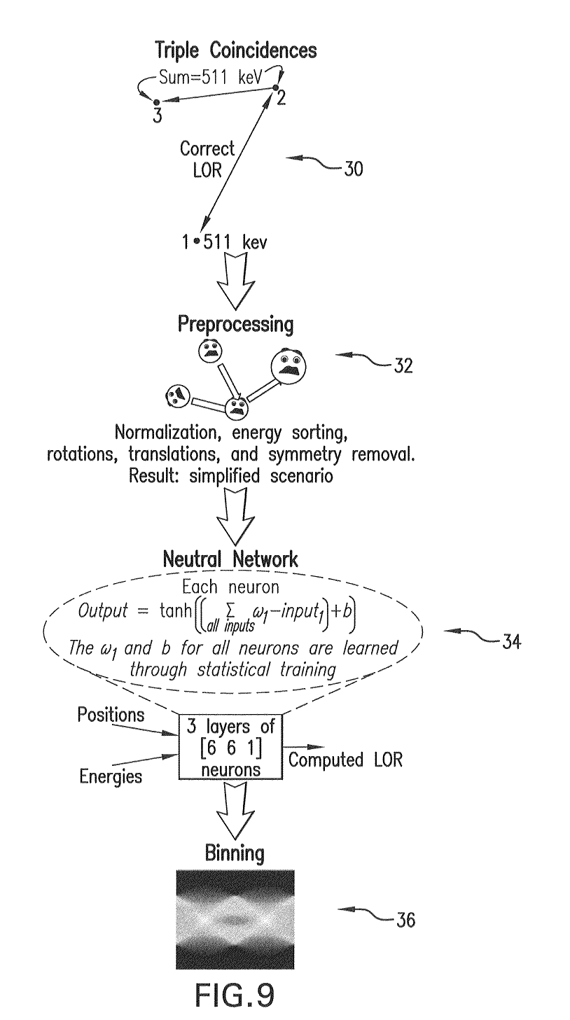

As expressed hereinabove, the method proceeds in two phases, comprising a first pre-processing, followed by artificial intelligence computation of the correct LOR, for example in a neural network. FIG. 9 is an illustrative example of a method for analysis of Compton-scattered photons according to an embodiment. FIG. 9 summarizes broad steps of a method of discriminating, in a PET scanner, between photoelectric photons and scattered photons lying on a LOR. Triple coincidences are first identified (30). Enhanced pre-processing by analysis of the triple coincidences, or triplets, follows (32), This pre-processing may be implemented in a processor, FPGA, DSP, or like devices. Decision and mitigation of LOR identification errors is then made within a neural network (34). Binning of the analyzed coincidences may follow (36).

Pre-processing as presented hereinabove can be further enhanced in terms of the method's performance, yielding a simpler neural network that can more readily discriminate the correct LOR. Pre-processing makes the neural network operate in a value-normalized and orientation-normalized coincidence plane rather than in the system-level coordinate reference. Another way to interpret pre-processing would be to express that it removes some or all symmetries and redundancies in the data, so that the multitude of possible triplets in a given scanner are superposed together and become one simple, generic case.

As described hereinbefore, detections are referenced globally, the x and y coordinates being in the transaxial plane, and z representing distance in the axial direction.

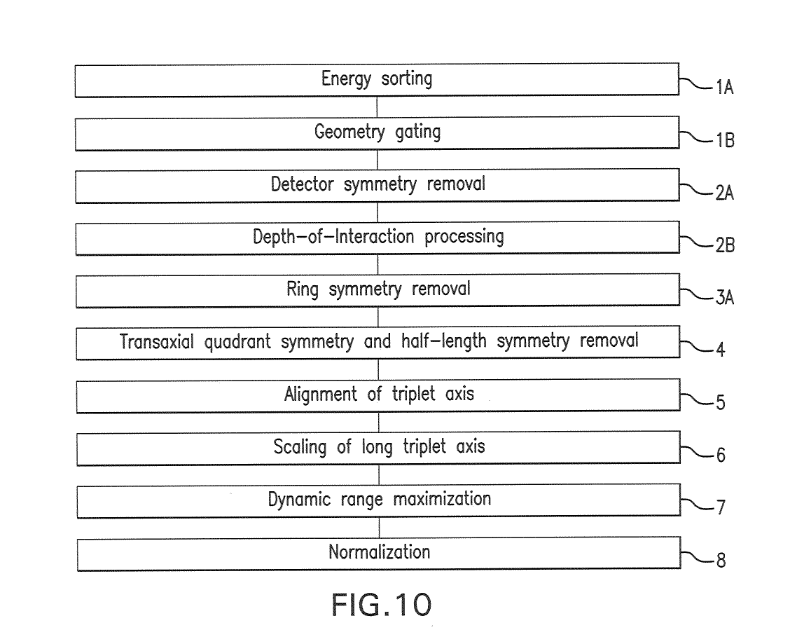

In an embodiment, enhanced pre-processing comprise several operations that may be expressed summarily as energy sorting inside a triplet, removal of data superposition in space arising from radial, longitudinal and quadrant symmetries of a scanner, removal of transaxial localization dependence, removal of axial localization dependence, and normalization. Those operations significantly reduce the dimensional complexity of the required neural network. However an embodiment may comprise a subset of the pre-processing operations. FIG. 10 is an example of a pre-processing sequence broken down into a number of optional operations. Some or all of operations 1A, 1B, 2A, 2B, 3A, 3B, 4A, 4B, 5A, 5B, 5C and 6-B may be included in an embodiment. The operations of FIG. 10 are made in a virtual space in order to simplify a presentation of measurements to the neural network. It should be understood that actual photons measurements are then used for producing an image represented by those photons.

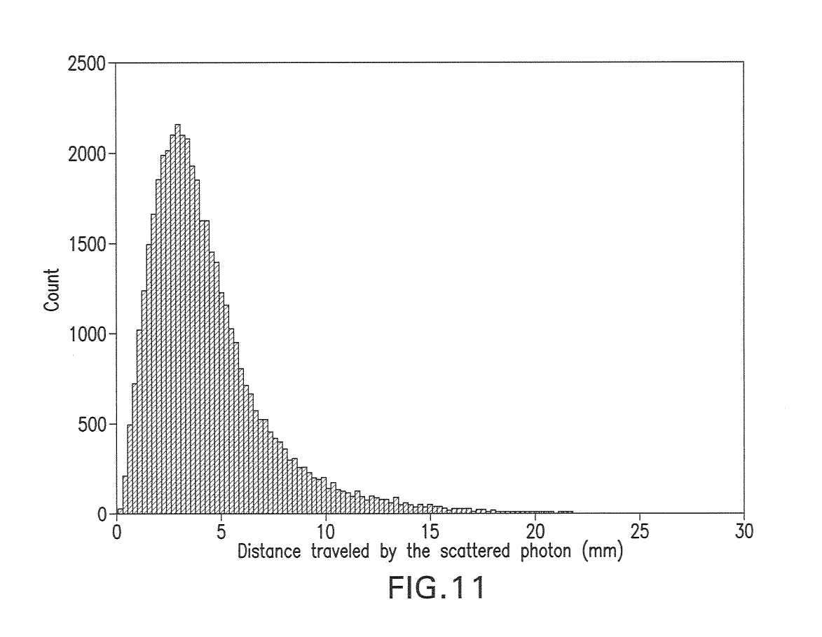

1A. Energy sorting: The detected photons are presented to the network in order of decreasing energy. In this way, the photoelectric photon appears first, and thus its energy has a known value that does not need to be presented to the neural network. However this operation as is may introduce backscatter artifacts in the presence of poor energy resolution because the photoelectric 511-keV photon, intended to be presented to the network first, may sometimes be swapped with a high-energy scattered one. This may be enhanced by adding a geometry criterion to the sort. As shown on FIG. 11, which is a histogram of distances travelled by scattered photons, the distance the scattered photon travels after a Compton interaction is usually small, as opposed to the true 511-keV photoelectric photon which usually lies on the other side of the scanner.

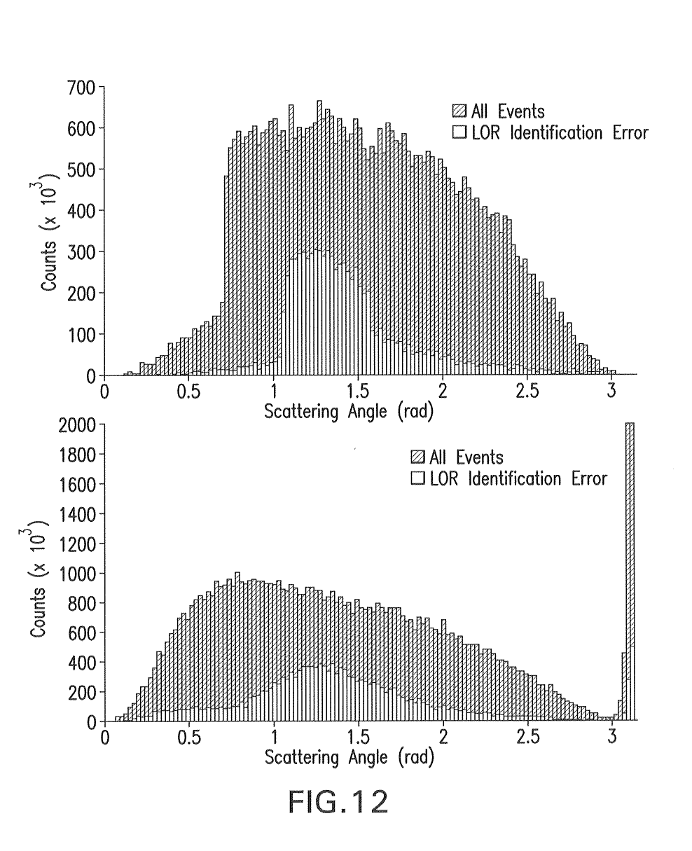

1B, Geometry gating: Operation 1A introduces backscatter artifacts in the presence of poor energy resolution because the 511-keV detection, intended to be presented to the network first, can be involuntarily swapped with the high-energy scattered one. This backscatter artifact can be seen on FIG. 12, which is a graph showing a distribution of triplet line-of-responses identification errors. On the bottom of FIG. 12, a standalone peak is present at pi radians. This may be corrected by imposing a further geometry criterion on the energy sort, since the distance the scattered photon travels after a Compton interaction is usually small, as opposed to the true 511-keV detection which usually lies on the other side of the scanner. Proper energy sort may be achieved that way. Bad triplets which crept through the coincidence engine may also be rejected, where because of poor energy resolution the high-energy scattered detection was mistaken for the 511-keV one when in fact there was no proper 511-keV detection in the triplet.

2A. Removal of detector symmetry around the scanner's center axial axis: A scanner usually has a high number of symmetries inside a given ring, which can be removed by rotating the whole triplet about the axial axis such that the 511-keV photon consistently ends up with the same coordinates.

2B. Depth-of-interaction (DOI) Processing for the photoelectric detection: Extending the 511-keV detection superposition rationale of operation 2A to radial-DCII-aware detections, the triplet may be translated in the x direction so that the coordinates of the 511-keV detections now lie on top of one another. The x and y coordinates of those photoelectric photons are now trivial and need not he presented to the network.

3. Ring symmetry: Many scanners comprise a plurality of rings, wherein the rings are generally identical. Ring symmetry may be removed by translation of the triplet along the axial axis such that the z coordinate of the photoelectric photon is consistently the same. That z coordinate likewise becomes trivial. At this point information about the photoelectric photon is trivial and can be omitted from the neural network's inputs.

4. Removal of transaxial quadrant symmetry and half-length symmetries: (A) In the transaxial plane, the scanner is symmetric with respect to an imaginary line, called a symmetry line, passing through the scanner center and through the photoelectric photon. That symmetry may be removed by mirroring the triplet about that line such that the y coordinate of the highest energy scattered photon has a positive sign. (B) Similarly, the scanner has an axial symmetry about a plane located at half its length, which may be removed by mirroring the triplet about that line such that the z coordinate of the highest energy scattered photon is consistently positive.

5. Alignment of the triplet axis: Up to this point, the photoelectric photons from the triplets are brought on a same axis and superposed by transformation, but the coincidence planes themselves are still randomly oriented. Defining the triplet axis as the line spanning between the photoelectric photon and the midpoint between the two scattered photons of a triplet, this may be corrected by up to three (3) rotations about the triplet axis. (A) A first rotation is in the transaxial plane, about an axis passing through the photoelectric photon and parallel to the scanner axial direction, by an amount such that the projection in the transaxial plane of the triplet axis coincides with the transaxial symmetry line described in operation 4A, (B) A second rotation is about an axis passing through the photoelectric photon, parallel to the transaxial plane and perpendicular to the scanner radius, by an amount such that the triplet axis itself now lies in the transaxial plane. (C) A third rotation is about the symmetry line described in operation 4(A) by an amount such that the vector between the two scattered photons is parallel to the transaxial plane. At this point, the scattered photons are brought on a same plane, and the z coordinate of the two scattered photons becomes trivial, and need not be presented to the neural network.

6. Scaling of triplet long axis: The triplet axes are now aligned, but the distance between the scattered photons' midpoint and the photoelectric photon is still random. This may be corrected by scaling the triplet along the symmetry line described in operation 4(A), such that the photoelectric photon stays stationary and the midpoints are now superposed. At this point, correct LORs tend to be superimposed on a single line regardless of the annihilation position within the scanner, with the limit that the correct LOR is still unknown and the superposition remains spread somewhat. At this point as well, the resulting trained neural network becomes universal, as the same network can be used with equivalent performance to discriminate the LOR of any dataset of a given scanner regardless of the data with which it was trained, effectively achieving source geometry independence.

7. Dynamic range maximization: Up to this point, the triplet triangle has been transformed to a fixed but arbitrary relationship to the referential origin. Since the 511-keV detection information has become trivial, only the scattered detections' transformed measurements remain pertinent for analysis. To maximize dynamic range utilization in the data presented to the neural network, the triplet may be translated along the x axis so that the scatter detections' midpoint coincides with the origin.

8. Normalization: Because the neural network used herein has a tan h( )activation function whose output ranges between −1 and 1, training converges more easily if the data also lies in that range. Measurements may thus be normalized to their respective maximum.

Computational complexity is a trade-off between pre-processing and the size of the neural networks. However, pre-processing can be performed at little extra cost, for example within a computer graphic display adapter chip, using its dedicated texture manipulation pipelines that are in fact transformation engines. As such, moving computational complexity into the pre-processing phase is not expensive. By opposition, feeding the raw data directly to the neural network would require that it fulfills a task equivalent to pre-processing by itself, requiring a much larger network.

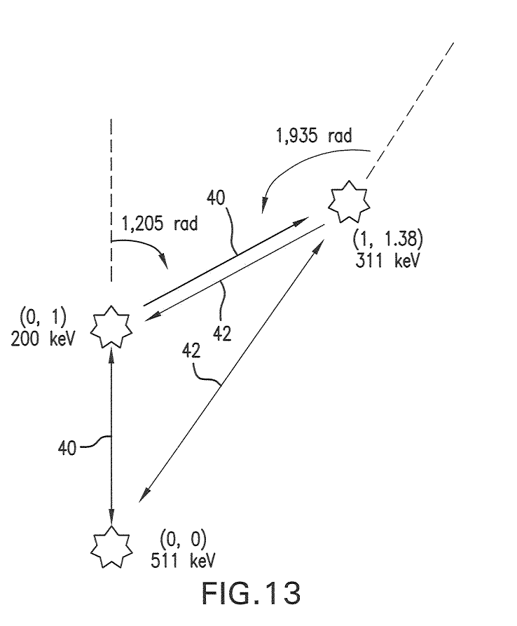

When photon time-of-flight information is insufficiently accurate or unavailable, some theoretically undistinguishable cases arises where the Compton kinematics work both ways, in the sense that the geometry and the energy in the triplet fit such that both the forward scattering scenario and the backscattering scenario are plausible. Such undistinguishable cases in theory only occur in the 170 to 340 keV energy range, or, in terms of scattering angle, between 1.05 and pi radians (60 and 180 degrees). FIG. 13 is 2D example of a situation wherein the Compton law is not sufficient to distinguish a forward-scattered photon from a backscattered photon. In FIG. 13, without time-of-flight information, it is impossible using the Compton law to determine whether forward (40) or backscatter (42) occurred, since both are plausible. Numbers in parenthesis are the x and y coordinates of the detections.

However, in a real scanner, detector size is finite and, without DOI measurement or other positioning methods, the detection position is quantized, usually to the center of the detector. This increases the energy and angle range of the undistinguishable cases, since it is not possible to compute the scattering angle with sufficient accuracy, either from the measured energy or from the coincidence geometry.

After pre-processing, the neural network learns how to minimize both the identification error arising from the measurement impairment and undistinguishable cases distribution in the training data.

In an embodiment, an algebraic process may be used to mitigate LOR identification errors. The role of the neural network, algebraic analysis process, or other suitable artificial intelligence system, is, within the LOR decision process, to mitigate LOR identification errors due to measurement impairments and to minimize errors in the theoretically indistinguishable cases.

The neural network is fed with the simplified measurements still pertaining to the ICS coincidence: the x, y coordinates and energy of the non-trivial 511-keV-sum scattered photons, for a total of 6 inputs. It computes which of the 2 photons lies on the LOR. Though the foregoing has described enhanced pre-processing, the task of the neural network fundamentally remains as expressed hereinabove, though the neural network itself or other artificial intelligence system may be simplified when enhanced pre-processing is used. Following identification of the photons on the LOR, the original detection coordinates are subsequently backtracked and fed to an image reconstruction software.

A Monte Carlo analysis of the above described method has been made using various point and cylinder sources. Because LOR computation in a real scanner can hardly reach an absolute certainty, simulation data is used to assess the method's performance. Here a GATE model, described at http://www.opengatecollaboration.org/, is used to produce a model of a simple scanner, generating proper list-mode Monte Carlo data.

A custom GATE pulse adder has been coded to circumvent the built-in adder's inclusion in the singles' centroid computation of electronic interactions subsequent to photonic ones (such as the photoelectric photons in the case of Compton scattering). The custom adder reports the energy of electronic interactions at the proper point of photonic interaction, discarding their localization. That way, individual contributors to LOR identification errors can be studied independently because the Compton kinematics remains exact at the singles level.

Although the method is intended to run on a real scanner, study of the method's performance on a real scanner model is suboptimal. Because of detector blocks, of packaging, and of readout specifics, modifying such parameters as detector size, ring size or DOI would require significant rework of the model. It is easier to choose a simpler test geometry. The simulated scanner is also purposely chosen with very poor performance, representative of the poorest characteristics obtained with current technology, in order to demonstrate that the method may be portable to most machines.

The energy resolution was tested at 0% (perfect) and 35% (worst-case) FWHM. The inner diameter is set at 11 cm, since a small diameter along with rather large detectors worsens angle errors between close detectors. The detector size is quantized at 2.7×2.7×20 mm³. The scanner is assumed to have 8 rings of 128 detectors, and Gd₂SiO_{L} (OSO), a material with relatively low stopping power, is employed to obtain a low photoelectric fraction. The detectors are not grouped. They are just disposed around the ring. Individual readout of each detector is made necessary by the need to discriminate the scattered photons in adjacent detectors.

For doublets, defined as coincidences consisting of two 511-keV photoelectric detections, the energy window for perfect energy resolution is set at 500 to 520 keV, while at 35% resolution the window extends from 332 keV to 690 keV. For triplets, the low energy cut is set at 50 keV. With perfect energy resolution, triplets are considered valid when one photon lies in a 500-520 keV range, indicative of positron annihilation, and the total energy sum lies within the 1000-1040 keV range. At 35% FWHM resolution, triplets are retained when at least one photon lies in a 332-690 keV range, and the total energy sum is within the 664-1380 keV range.

In this embodiment, the neural network has a standard feedforward architecture, and the non-linear activation function of layers is the hyperbolic tangent function.

In this embodiment, the neural network is trained by backpropagation of the error, using the well-known Levenberg-Marquardt quasi-Newton optimization algorithm. Training uses a variable-size data set ranging from 600 to 15,000 random triplets indifferently, with similar outcome. Training is stopped using a validation set, and ends when the generalization capability of the network has not improved for 75 epochs.

The neural network is trained with discrete target values of −1 and 1 to indicate which of the scattered photons actually lies on the LOR, but in practice the value 0 is used as a discrimination boundary, everything lying on one side of the boundary being assumed belonging to the discrete value on that side.

Weights and biases within the neural network are initialized randomly before training. Like with many non-linear optimization methods, training is thus a non deterministic process, and no information can be recovered from the dispersion of the training results. After at least 15 training tries, the neural network with the best performance is simply retained.

Preliminary tests assessed the performance versus network complexity trade-off. Those tests used point sources and very small data sets with usually less than 20,000 triplets.

A radiation source was moved across a Field Of View (FOV) of the scanners to measure the LOR identification error rate, defined as the ratio of the number of triplets where the wrong scattered photon was computed as being on the LOR, over the total number of triplets. The sensitivity increase was also measured and defined as the ratio of the number of triplets over the number of doublets in a given test set. The sensitivity increase is a direct measure of the scanner sensitivity increase that would result from the inclusion of triplets in the image reconstruction.

The data set used for those tests is relatively small, with usually less than 75,000 triplets.

A cylinder source of 20 mm radius and 20 mm length was also simulated using approximately 250,000 triplets. For that cylinder a binary IDI set at half the detector height (10 mm) was also tried. Furthermore, smaller detectors were also tried, and the scanner was modified to have 11 rings of 172 detectors sized at 2×2×20 mm³, resulting in approximately the same FOV, also with binary DOI.

The method has been implemented in Matlab, from MathWorks™, for those tests and, again, in this embodiment, the resulting network complexity is 6 inputs (energy as well as x and y coordinates of the two scattered photons), 6 neurons on a single hidden layer, and a single output neuron, or [6 6 1],

The same cylinder configuration was used to reconstruct images, using at perfect energy resolution 5.64 million doublets and 3.85 million triplets, and at 35% FWHM energy resolution, 9.89 million doublets and 5.23 million triplets.

“Tomographic Image Reconstruction Interface of the Université de Sherbrooke” (TIRIUS), a reconstruction software described at http://www.pages.usherbrooke.ca/jdleroux/Tirius/TiriusHome.html, uses a 3D Maximum-Likelihood Expectation Maximization (MLEM) method with a system matrix approximated with Gaussian tubes of responses measuring 2.25 mm FWHM ending in the detector centers. Ten (10) iterations were sufficient to obtain the images.

The reconstructed Region Of Interest (ROI) measures 90 mm in diameter and 21.6 mm axial length. Images have 96×96×24 voxels, for an equivalent voxel size of 0.9375×0.9375×0.9 mm³.

A resolution-like source was also used to reconstruct images, with 6.21 million doublets and 4.66 million triplets at perfect energy resolution, and with 11.2 million doublets and 6.26 million triplets at 35% FWHM energy resolution. The resolution phantom has 8 cylindrical hotspots 5.0, 4.0, 3.0, 2.5, 2.0, 1.75, 1.50 and 1.25 mm in diameter and 20 mm in length, of equal activity density per unit volume, and arranged in symmetrical fashion at 10 mm around the FOV center.

Images were zoomed in 10-times post-reconstruction using bicubic interpolation,

Because of the sheer size of the files involved in image reconstruction, the process was ported to C++ programming language. However, pre-processing operations 5(B), 5(C) and 6 were not coded for simplicity. For the image results, the networks thus have 8 inputs (the 6 inputs previously stated plus the z coordinates of the two scattered photons), 10 neurons on a first hidden layer, 10 neurons on a second hidden layer and a single output neuron, or [8 10 10 1].

A preliminary analysis of the performance achievable along with the required network complexity is presented in Table 4, which represents performance and network complexity achieved as a function of used pre-processing operations. It should be observed that a performance attained with no pre-processing is similar to “traditional” methods employing explicit Compton kinematics models in similar conditions.

TABLE 4

| Pre-processing | LOR Identification Error | |
|---|---|---|
| Operations | (Approx. %) | Network Complexity |
| 8 only | 40 | [12 10 10 10 1] |
| 1, 2, 3 and 8 | 30 | [8 10 10 1] |
| 1 thru 4, 5A and 8 | 25 | [8 10 8 1] |
| All | 20 | [6 6 1] |

In the rightmost column of Table 4, the first number within each square bracket identifies a number of data inputs, the last number identifies a single output neuron, and each number in between identifies a number of neurons in distinct hidden neuron layers. Table 4 demonstrates that improvements in reduction of LOR identification error and neural network complexity are already possible even with a limited subset of the pre-processing operations listed hereinabove.

Table 5 summarizes performance results for a point source moved across the FOV for energy resolutions of 0% and 35% FWHM.

TABLE 5

| Source | | | | |
|---|---|---|---|---|
| Position | | | | |
| from | | | | |
| FOV Center | LOR Identification | | Sensitivity Increase | |
| (Radial mm, | Error (%) | | (%) | |
| Axial mm) | 0% FWHM | 35% FWHM | 0% FWHM | 35% FWHM |
| (0, 0) | 4.1 | 8.4 | 68 | 109 |
| (0, 5) | 7.3 | 8.1 | 69 | 113 |
| (0, 10) | 3.1 | 18.7 | 41 | 71 |
| (5, 0) | 17.8 | 16.6 | 68 | 109 |
| (10, 0) | 19.8 | 19.1 | 64 | 106 |
| (20, 0) | 19.1 | 18.3 | 51 | 83 |
| (40, 0) | 20.9 | 19.8 | 34 | 59 |
| (5, 5) | 18.3 | 21.1 | 68 | 112 |
| (10, 10) | 18.1 | 21.3 | 38 | 64 |

When the source is on the scanner axis, computing the correct LOR is in theory trivial since the LOR consistently passes through the scanner center. Most of the time, the network is able to learn that from the data, and the LOR identification error is low, below 10%.

Because of pre-processing, the LOR identification error shows otherwise no statistically significant dependence on the source position, consistently ranging roughly from 18 to 21%. The variability observed is attributable at least in part to the nondeterministic results of network training, as explained earlier. This is significant improvement over “traditional” methods, which were not able to achieve better than 38% LOR identification error.

The energy resolution shows no statistically significant impact on LOR identification error.

Returning to FIG. 12, identification error distribution is shown as a function of the photon scattering angle within the triplet for one of the point sources. Distribution of triplet LOR identification errors as a function of the scattering angle is shown for perfect (top) and 35% FWHM (bottom) energy resolutions, for a point-source at 5 mm radial distance, 0 mm axial distance from the center of the FOV. Other point-source positions exhibit similar error distribution. Histograms of FIG. 12 were obtained by measuring the scattering angle using the exact interaction position as reported by the custom GATE adder, and not the angle computed from the position quantized to detector centers.

With ideal energy resolution the impact of scanner geometry (FIG. 12, top) is very apparent through the sharp transition in triplet count at approximately 0.7 radians which is, for the simulated geometry, the smallest angle for inter-crystal scatter coincidence with only 3 photonic interactions. The tail below the transition is comprised of apparent triplets which are in fact recombination in finite detector of multiple scattering interactions. The LOR identification errors in that perfect energy resolution case are concentrated in the undistinguishable cases range.

With degraded energy resolution (FIG. 12, bottom) and its widened energy window, the distribution lacks the sharp transition because more “false” triplets get through, Those false triplets consist mainly of coincidences where the annihilation energy was not detected but still got through screening because of poor energy resolution. The distribution shows a backscatter artifact peak at pi radians, which can be corrected using enhanced pre-processing. Image quality is good despite that artifact.

Table 6 shows the cylinder phantom performance results, for a 40 mm diameter, 20 mm length cylindrical source.

TABLE 6

| | LOR Identification | | Sensitivity Increase | |
|---|---|---|---|---|
| | Error (%) | | (%) | |
| | 0% | 35% | 0% | 35% |
| Conditions | FWHM | FWHM | FWHM | FWHM |
| 2.7 mm detectors | 25.8 | 21.3 | 56 | 96 |
| 2.7 mm detectors, DOI | 25.0 | 21.2 | 59 | 95 |
| 2.0 mm detectors, DOI | 24.3 | 20.4 | 54 | 96 |

A DOI resolution of 10 mm, as simulated here, has little impact on performance. It is anticipated that DOI does not improve the method when its resolution is worse than the average distance travelled by the scattered photon (FIG. 11).

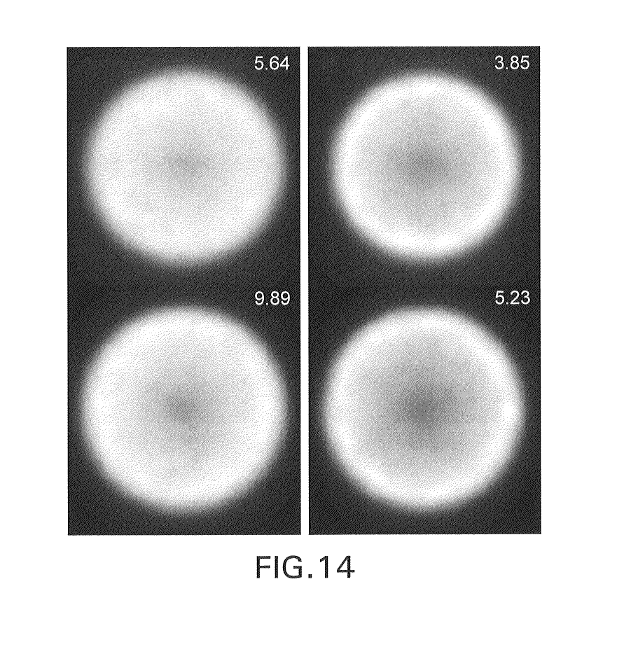

FIG. 14 is a first zoomed view of a region of interest of images reconstructed using photons processed with the method of the present disclosure. The ROI is viewed at a center slice from the image of the cylinder phantom. Each individual image includes either only doublets (left) or triplets (right), with perfect (top) and 35% RAM (bottom) energy resolution. The numbers superimposed text shows the event count (in millions) of the reconstructed images.

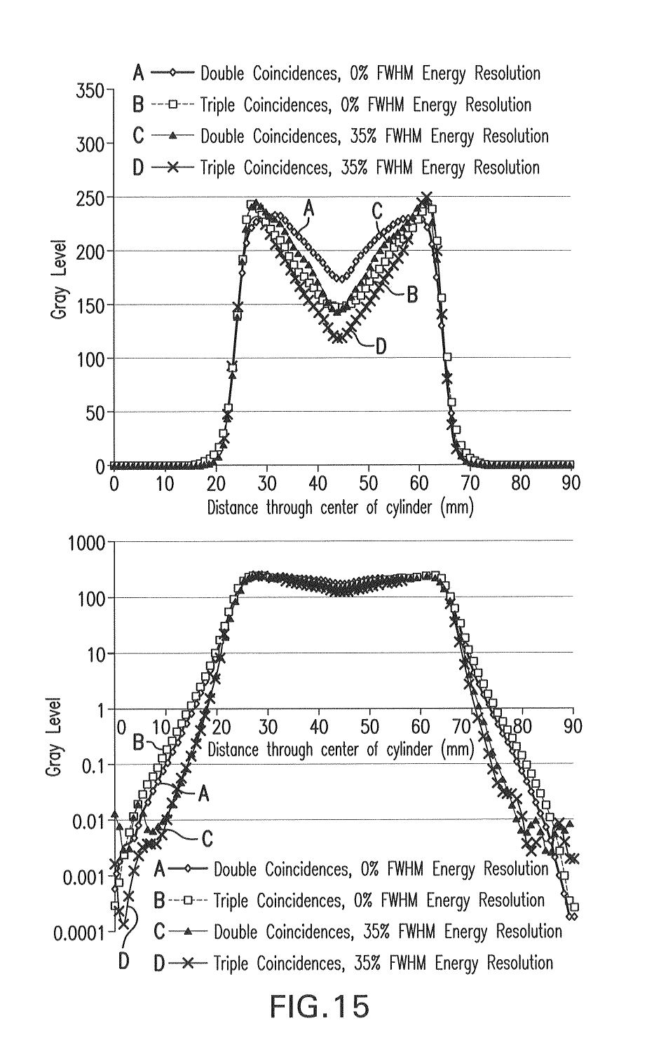

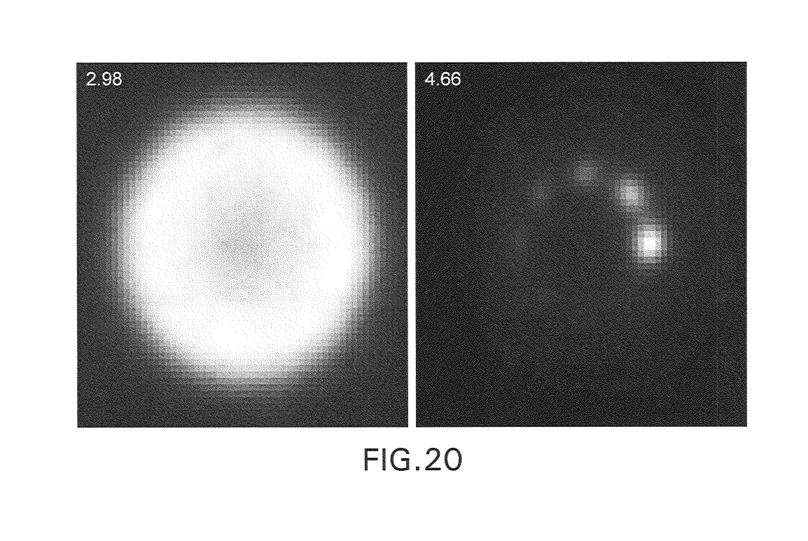

FIG. 15 shows profiles of levels of gray within FIG. 14. Gray profiles are shown along a line passing through the middle of the images in FIG. 14. At the top of FIG. 15, gray-level profiles of those images are shown on a linear scale. Significant non-uniformity of the cylinder interior may be observed. This is attributable to an approximated system matrix, and can be corrected through the use of an analytical system matrix. This is exemplified in FIG. 20, which is a third zoomed view of a region of interest. In contrast with FIGS. 14 and 17, FIG. 20 is obtained using a proper analytical system matrix.

On a logarithmic scale (FIG. 15, bottom), the “walls” of the cylinder appear sharper and more abrupt at 35% FWHM. This may be due to either or both of two reasons. A first one is the fact that performance studies show that the cylinder source does yield less LOR identification rate at 35% FWHM. A second one is image statistics. Indeed, the results are based on a constant simulation length for all images, resulting in different event counts because of varying sensitivity amongst individual images, and subsequently in different intrinsic image quality.

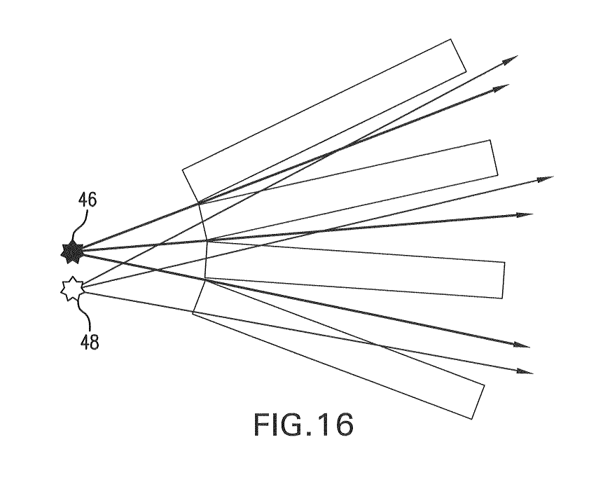

FIG. 16 is a view of position-dependent sensitivity in a simulated dummy scanner. The image is not to scale and is distorted to emphasize the fact that the detectors show gaps where the effective stopping power is lower to a source exactly at the center of the FOV (46) when compared to a source offset from the center (48). Training the neural network with data from a particular scanner can compensate for these geometry effects.

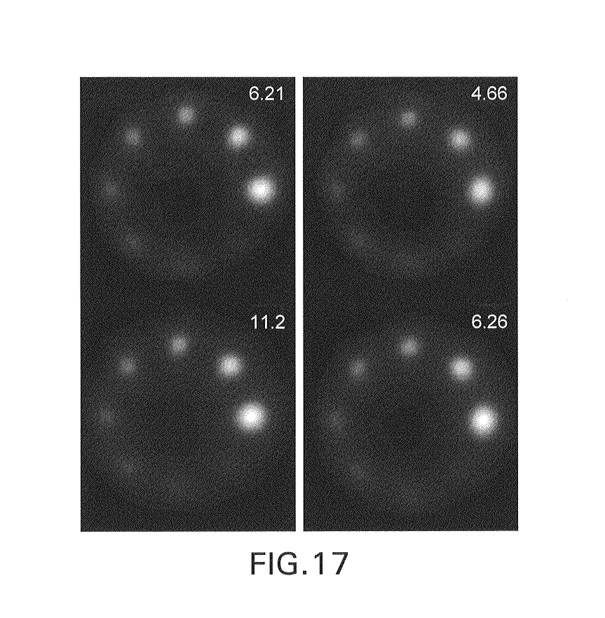

FIG. 17 is a second zoomed view of a region of interest. The Figure shows a zoomed view of the ROI of the center slice from the resolution phantom image. Again each individual image is comprised of only doublets (left) or triplets (right), at either perfect (top) or 35% FVVHM (bottom) energy resolution. Superimposed text shows the event count (in millions) for each reconstructed image.

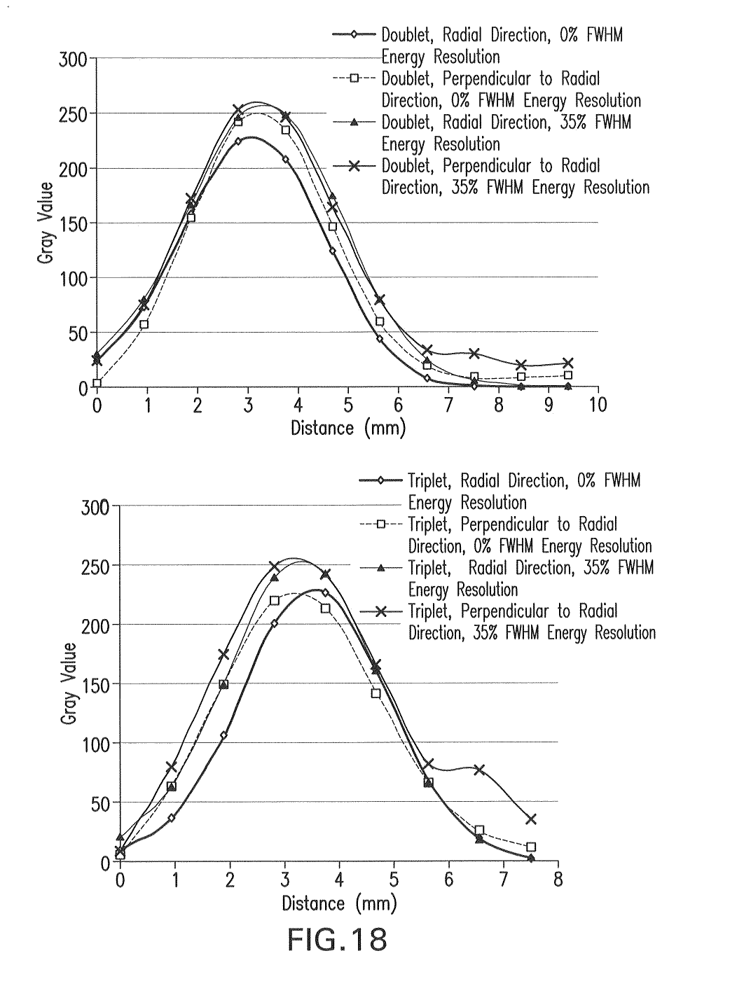

In the triplet images, the hotspots look slightly oblong, but again this is dependent on using a proper system matrix, as shown on FIG. 29. FIG. 18 shows profiles of levels of gray within FIG. 17, as seen in a first direction, Profiles show gray levels in the 5-mm hotspot in the radial direction and along a line perpendicular to the radius, for doublets (top) and for triplets (bottom).

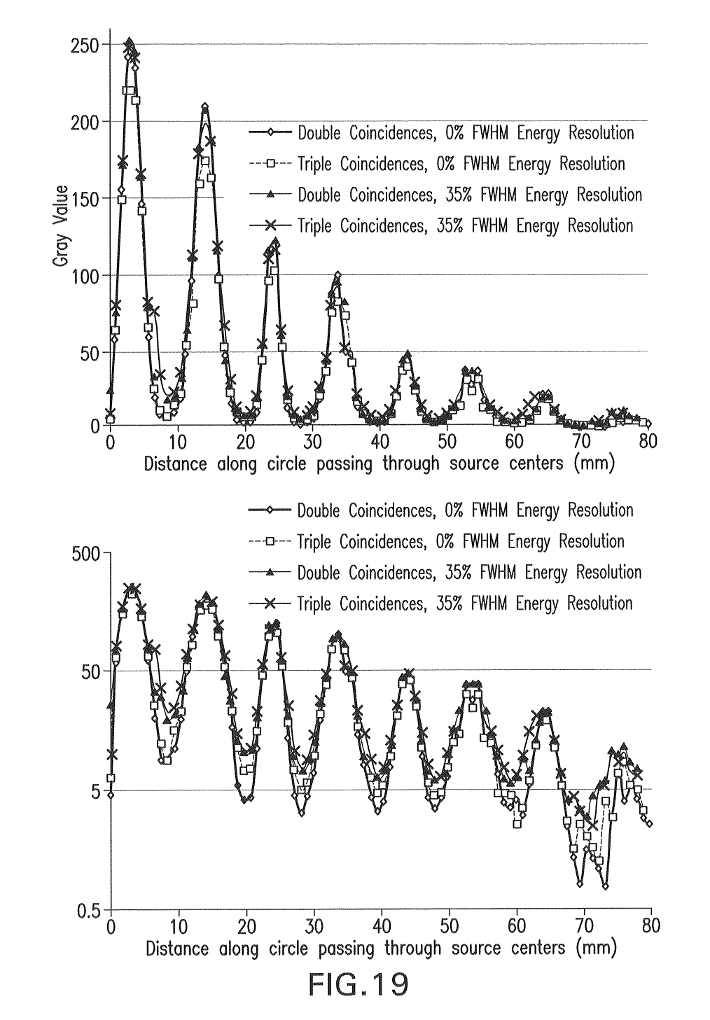

FIG. 19 shows profiles of levels of gray within FIG. 17, as seen in a second direction. Profiles show the gray levels in the hotspots along a circle passing through their center on a regular (top) and logarithmic (bottom) vertical axis. Gray-level profiles of the resolution phantom also have little or no degradation from perfect to 35% FVVHM energy resolution. However, the logarithmic scale (FIG. 19, bottom), does show that valleys between the hotspots at 35% FVVHM energy resolution are slightly shallower than those at perfect energy resolution.

Otherwise, the simulated triplet images presented herein are of comparable quality to doublet images, even with slightly poorer statistics, which means the sensitivity of a scanner could be substantially increased without compromising image quality.

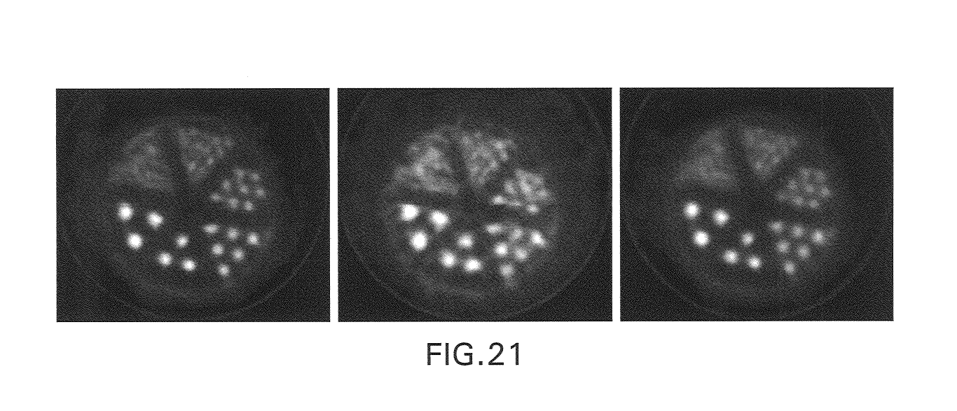

As another embodiment example, the method has been implemented offline on a LabPET™ scanner. FIG. 21 is a comparison between an image obtained with traditional methods and images obtained using enhanced pre-processing. A left part shows an ordinary ultra-micro-derenzo hotspot phantom image using traditional detection selection and image reconstruction methods. A middle part shows an image reconstructed only from the triplets selected and processed with the method described herein. A right part shows a combination of the two preceding data sets.

The method presented hereinabove shows very good performance with low 1.0R identification error (15-25%), high sensitivity increase (70-100%) and images of very good quality. Real-time implementation of the method, including a simple neural network, may run in an FPGA, with more computationally intensive pre—processing offloaded to another processor such as, for example, a graphics processing unit.

The above described method can be used in real-time or offline, and its implementation can take several forms like, for example, software, DSP implementation or FPGA code. Results from the method, or the method itself, may eventually serve or aid in the analysis of other phenomena in the machines such as, for example, in random coincidence rate estimation.

Those of ordinary skill in the art will realize that the description of the method and apparatus for analysis of Compton-scattered photons in radiation detection machines are illustrative only and are not intended to be in any way limiting. Other embodiments will readily suggest themselves to such skilled persons having the benefit of this disclosure. Furthermore, the disclosed method and apparatus can be customized to offer valuable solutions to existing needs and problems of losses of spatial resolution at high sensitivity levels.

In the interest of clarity, not all of the routine features of the implementations of the method and apparatus are shown and described. It will, of course, be appreciated that in the development of any such actual implementation, numerous implementation-specific decisions are routinely made in order to achieve the developer's specific goals, such as compliance with application-, system-, and business-related constraints, and that these specific goals will vary from one implementation to another and from one developer to another, Moreover, it will be appreciated that a development effort might be complex and time-consuming, but would nevertheless be a routine undertaking of engineering for those of ordinary skill in the fields of artificial intelligence and of positron emission tomography having the benefit of this disclosure.

Although the present disclosure has been described hereinabove by way of non-restrictive illustrative embodiments thereof, these embodiments can be modified at will within the scope of the appended claims without departing from the spirit and nature of the present disclosure.

What is claimed is:

1. A method of identifying line-of-responses (LOR) of photons, comprising:
measuring the photons in a radiation detection machine; and
performing pattern recognition of the measured photons to mitigate LOR identification errors.

2. The method of claim 1, comprising:
computing the LORs using pattern recognition.

3. The method of claim 1, wherein:
mitigating LOR identification errors comprises an implicit or explicit mitigation of measurement values.

4. The method of claim 1, comprising:
detecting the photons through photoelectric interaction within a detector.

5. The method of claim 1, comprising:
detecting the photons following Compton scattering within a detector.

6. The method of claim 1, wherein:
pattern recognition is performed using an algebraic classifier.

7. The method of claim 1, wherein:
pattern recognition is performed using on artificial intelligence technique.

8. The method of claim 7, wherein:
a neural network implements the artificial intelligence technique.

9. The method of claim 1, comprising:
before performing the pattern recognition, pre-processing measurements of the photons using an element selected from the group consisting of geometrical processing, numerical processing, filtering, normalizing, and a combination thereof.

10. The method of claim 1, wherein:
the radiation detection machine is a positron emission tomography (PET) apparatus and the photons are positron annihilation photons.

11. The method of claim 10, comprising:
identifying, in the PET apparatus, a plurality of positron annihilation photons (i) as photoelectric photons having an energy level within a range indicative of positron annihilation, or (ii) as one or more scattered photons having an energy sum within the positron annihilation energy range.

12. The method of claim 11, comprising:
identifying a plurality of photon groups, each photon group comprising a detected photoelectric photon and one or more detected scattered photon.

13. The method of claim 12, comprising:
pre-processing the measurements of the photons by normalizing the measurements within a predetermined range;
wherein performing pattern recognition of the measured photons to mitigate the LOR identification errors comprises a pattern recognition analysis of the normalized measurements.

14. The method of claim 13, wherein:
a neural network executes the pattern recognition.

15. The method of claim 14, wherein:
the neural network comprises an element selected from the group consisting of a hyperbolic tangent function, a multilayer feedforward architecture, a training function using back-propagation of the error computed using Monte-Carlo simulated data, and a combination thereof.

16. The method of claim 13, comprising:
before the step of normalizing, aligning the photoelectric photon trajectories by rotation and translation, whereby the trajectories are brought on a same axis.

17. The method of claim 16, wherein:
after the step of aligning and before the step of normalizing, rotating further the photoelectric photons about their axis, whereby the photon groups are brought in a same plane.

18. The method of claim 1, comprising:
constructing an image based on a plurality of LORs.

19. An apparatus for identifying line-of-responses (LOR) of photons, comprising;
a radiation detector for measuring photons; and
a first processor for performing pattern recognition of the measured photons to mitigate LOR identification errors.

20. The apparatus of claim 19, wherein:
the first processor is further capable of computing the LORs.

21. The apparatus of claim 19, wherein:
the first processor comprises a neural network.

22. The apparatus of claim 21 comprising:
a second processor for normalizing measurements of photons within a predetermined range.

23. The apparatus of claim 19, comprising:
a second processor for aligning trajectories of the measured photons by rotation and translation, whereby the trajectories are brought on a same axis or on a same plane.

24. The apparatus of claim 19, wherein:
the radiation detector is capable of detecting photons resulting from positron annihilation.

25. The apparatus of claim 19, wherein:
the first processor comprises an algebraic classifier.
